(19) United States
(12) Patent Application Publication
(10) Pub. No.: US 2024/0400932 A1
(43) Pub. Date: Dec. 5, 2024

(54) SPIRO COMPOUND AS DETERGENT ADDITIVE IN LUBRICANTS FOR MARINE ENGINES

(71) Applicant: TOTALENERGIES ONETECH, COURBEVOIE (FR)

(72) Inventors: Valérie DOYEN, SOLAIZE (FR); Gregory CHAO, SOLAIZE (FR); Modestino DE FEO, SOLAIZE (FR)

(21) Appl. No.: 18/699,168

(22) PCT Filed: Oct. 6, 2022
(86) PCT No.: PCT/EP2022/077844

§ 371 Date: Apr. 5, 2024

(30) Foreign Application Priority Data
Oct. 7, 2021 (FR) FR2110617

(51) Int. Cl. C10M 169/04; C07F 5/04; C10M 135/02; C10M 135/10; C10M 139/00; C10M 141/12; C10N 30/04; C10N 30/10; C10N 40/26

(52) U.S. Cl. CPC C10M 169/04; C07F 5/04; C10M 135/02; C10M 135/10; C10M 139/00; C10M 141/12; C10M 2203/003; C10M 2219/02; C10M 2219/046; C10M 2227/062; C10N 2030/04; C10N 2030/10; C10N 2040/26

(57) ABSTRACT

The present patent application relates to the use, as detergent additive in a lubricating composition intended for a marine engine, of at least one spiro compound of formula (I)

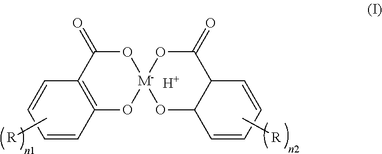

in which M is an atom chosen from boron and aluminum; n1 and n2 have, independently of one another, the value 0, 1 or 2; and R represent, independently of one another, a hydrocarbon group comprising from 1 to 50 carbon atoms, in particular from 5 to 20 carbon atoms.

It also relates to the use of said spiro compound as additive in a lubricating composition intended for a marine engine, for improving the stability to oxidation of said lubricating composition.

Finally, it relates to a lubricating composition intended for the lubrication of a marine engine, comprising one or more base oils and at least one spiro compound of formula (I), and also to a process of lubrication of a marine engine employing such a composition.

### TECHNICAL FIELD

The present invention relates to the field of lubricating compositions and more particularly to the field of lubricating compositions intended for the lubrication of marine engines, in particular two-stroke or four-stroke marine engines. It relates more particularly to the use of spiro compounds as detergent additives in lubricants for marine engines.

Advantageously, the invention makes it possible to achieve a lubricant exhibiting excellent properties of detergency and of stability to oxidation, while maintaining a low ash content.

### PRIOR ART

Marine engines, such as two-stroke or four-stroke marine engines, employ lubricants, also known as “marine oils”, to provide the lubrication of the various parts of the engine. For example, slow two-stroke crosshead marine engines employ, on the one hand, “cylinder” oils providing the lubrication of the piston-cylinder assembly or of the piston-ring-liner area and, on the other hand, “system” oils providing the lubrication of all the moving parts other than the piston-cylinder assembly or outside the piston-ring-liner assembly.

Until recently, the basicity was a decisive criterion in the formulation of lubricating oils, especially cylinder oils. This is because the lubricating oils within the piston-cylinder assembly are in contact with the combustion residues of the fuel, it being possible for these residues to contain, when they originate from high sulfur content fuels, significant amounts of acid gases. In fact, during the combustion of high sulfur content fuels, acid gases are formed: these are in particular sulfur oxides (SO₂, SO₃), which are subsequently hydrolyzed, during contact with the moisture in the combustion gases and/or in the oil, to generate sulfurous acid (HSO₃) or sulfuric acid (H₂SO₄).

The neutralization capacity of lubricating oils, expressed by their base number (BN, sometimes referred to as TBN for “total base number”), measured according to the standard ASTM D-2896, was thus a criterion of choice, making it possible to adjust the basicity of the lubricant employed to the sulfur content of the fuel used, in order to be able to neutralize all the sulfur contained in the fuel and liable to be converted into sulfuric acid by combustion. Thus, the higher the sulfur content of a fuel, the higher the BN of the marine lubricant had to be. Commercially available marine lubricants can thus exhibit BN values ranging up to 140 mg KOH/g.

The basicity desired for the lubricant was conventionally contributed by detergents overbased by insoluble metal salts, in particular metal carbonates, such as calcium carbonate. These detergents are in particular metal soaps of salicylate, phenate, sulfonate or carboxylate type, which form micelles where the particles of insoluble metal salts are kept in suspension.

A portion of the BN can also be contributed by non-overbased or “neutral” metallic detergents.

With new engine types and new fuels, the basicity of the lubricant required to meet new needs is no longer so critical; indeed, even a reduction in conventional overbased detergents becomes necessary.

In fact, new regulations established in the light of environmental concerns have imposed limits in terms of sulfur levels in the fuels used on ships, which also implies reducing the content of metallic detergents in the lubricating oils of marine engines.

This is because an excess of metallic detergents, and thus of basic sites, with respect to a low sulfur content fuel employed, is liable to induce a risk of destabilization of the micelles of unused overbased detergents, which contain insoluble metal salts. This destabilization can result in the formation of deposits of insoluble metal salts (typically calcium carbonate) exhibiting high hardness, mainly on the piston crown of the engine, and, in the long term, can lead to a risk of excessive wear of liner polishing type.

It is known that sulfated ash, and also phosphorus and sulfur, can damage the systems for the aftertreatment of exhaust gases which from now on equip all new vehicles in order to eliminate harmful emissions, such as NOx, CO or soot.

Also, a filter fouled because of nonincinerated materials can induce an increase in the consumption of fuel and thus result in a waste of fuel, which goes against the properties desired in terms of reducing the consumption of marine fuel.

Thus, it appears necessary to reduce the content of metallic detergents, in particular of overbased metallic detergents, typically based on calcium carbonate, employed in marine lubricants.

However, a decrease in the content of metallic detergents also amounts to reducing the detergent capacities of lubricants below the required levels.

In point of fact, it is essential for the lubricants for marine engines, which are directly in contact with the engine and in particular with the hot portion of the engine, such as, for example, the piston-cylinder assembly, to exhibit good stability at high temperatures, in order to reduce or prevent the formation of deposits at the surface of metal parts, which are harmful to the engine.

Consequently, there exists a need to have available new compounds, which are alternatives to metallic detergents, in particular to overbased metallic detergents, capable of providing the marine lubricant with the desired detergency properties, while generating little ash, and thus making it possible to provide, under the high temperature conditions encountered in marine engines, good properties in terms of cleanliness of the engine.

For example, the document WO 2014/180843 provides a cylinder lubricant for a marine engine, usable both with high sulfur fuel oils and low sulfur fuel oils, and having in particular good thermal resistance, combining a metallic detergent overbased by metal carbonate salts, a neutral detergent and a fatty amine of specific BN, in particular a tetraamine.

The applications WO 2018/220007 and WO 2018/220009 provide, for example, the use of compounds derived from salicylic acid, products of the reaction between salicylic acid, a boron compound and an amine compound, for example of the polyamine type, to formulate lubricating compositions for marine engines, in particular for two-stroke marine engines, combining good corrosion resistance properties, good wear resistance properties and good detergency performance qualities.

### DISCLOSURE OF THE INVENTION

The present invention is targeted at providing a means for contributing excellent detergency properties to a lubricant intended for the lubrication of a marine engine, while having a low impact on the ash content.

More particularly, the invention relates, according to a first of its aspects, to the use, as detergent additive in a lubricating composition intended for a marine engine, for example a two-stroke or four-stroke engine, of at least one spiro compound of following formula (I) [Chem 1]

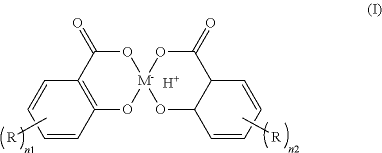

in which:
M is an atom chosen from boron (B) and aluminum (Al), in particular is a boron atom;
n1 and n2 have the value, independently of each other, of 0, 1 or 2; and
R represent, independently of one another, a hydrocarbon group comprising from 1 to 50 carbon atoms, in particular from 5 to 20 and more particularly from 5 to 20 carbon atoms.

Preferably, the spiro compound employed according to the invention is of abovementioned formula (I), in which M is a boron atom. In other words, according to this particular embodiment, the spiro compound is a compound known as a “spiroboronate compound”, of following formula (I′):

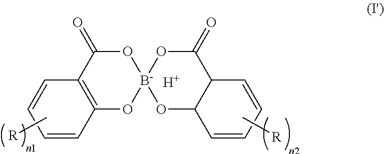

in which n1, n2 and R are as defined above.

Within the meaning of the present invention, the term “detergent additive” is intended to denote a compound which, introduced into a lubricating oil, makes it possible to contribute and/or increase its detergency capacities and thus to reduce, prevent, indeed even remove, deposits in the engine.

In the continuation of the text, the term “spiro compound” according to the invention will more simply denote a spiro compound of formula (I) as defined above, in particular a spiroboronate compound of formula (I′) as defined above. Examples of spiro compounds considered according to the invention are described more precisely in the continuation of the text.

More simply, the term “marine lubricant” denotes a lubricant intended for the lubrication of a marine engine. The marine lubricants considered according to the invention are appropriate for employment for the lubrication of two-stroke or four-stroke marine engines, in particular for two-stroke marine engines.

It can be a lubricant known as a “cylinder lubricant” employed for the lubrication of the piston-cylinder assembly of the engine, a lubricant known as a “system lubricant” employed for the lubrication of all the moving parts of the engine outside the piston-cylinder assembly, or also a lubricant known as a “crankcase lubricant” employed for the lubrication of the entire engine, including the piston-cylinder assembly, in particular in a 4-stroke engine.

The invention also relates, according to another of its aspects, to a lubricating composition intended for the lubrication of a marine engine, in particular of a two-stroke or four-stroke engine, comprising at least:
one or more base oils;
at least one spiro compound of formula (I) as defined above and described in detail in the continuation of the text, in particular at least one spiroboronate compound of formula (I′).

According to a particular embodiment, a lubricating composition according to the invention comprises, besides said spiro compound(s) according to the invention, one or more other detergent additives, in particular chosen from metallic detergent additives conventionally used in the field of lubricants, in particular based on calcium or on magnesium.

As illustrated in the examples which follow, the inventors have discovered that the employment of a spiro compound according to the invention makes it possible to achieve a marine lubricant exhibiting equivalent and even improved thermal resistance properties, compared to a lubricant incorporating conventional metallic detergents, and thus to provide good engine cleanliness, in particular of the ring-piston-cylinder area.

The detergency properties of the marine lubricant can be assessed via the evaluation of the performance qualities of the lubricant in terms of thermal resistance by tests of ECBT type, as described in the publication entitled “Research and Development of Marine Lubricants in ELFANTAR France—The Relevance of Laboratory Tests in Simulating Field Performance” by Jean-Philippe Roman, Marine Propulsion Conference, 2000—Amsterdam—March 29-30, 2000.

These tests give an account of the tendency of the marine lubricant to form deposits/varnishes under the conditions encountered during its employment in a marine engine, in particular in the ring-piston-cylinder area of the engine.

Moreover, said spiro compound(s), employed as detergent additives according to the invention, generate little ash in comparison with conventional metallic detergents.

Consequently, the incorporation in a marine lubricant of one or more spiro compounds according to the invention advantageously makes it possible to increase the detergency capacities of the lubricant, without negatively impacting the content of ash generated by the lubricant.

Advantageously, as illustrated in the examples, it is possible to employ one or more spiro compounds according to the invention, in order to partially replace the metallic detergents conventionally employed in a marine lubricant and which are undesirable given the ash which they generate, while preserving, indeed even while improving, the thermal resistance of the marine lubricant, and thus its detergency capacity.

Advantageously, it is thus possible to reduce the harmful effects in terms of ash content, in particular sulfated ash content, related to the use of metallic detergents, in particular overbased detergents, without however impacting, indeed even while improving, the thermal resistance and detergency properties of the lubricant.

A lubricating composition according to the invention thus makes it possible to combine excellent detergency properties and a low ash content, in particular sulfated ash content.

Advantageously, the employment of a spiro compound according to the invention thus makes it possible to achieve a marine lubricating composition exhibiting good properties in terms of engine cleanliness, in particular in the ring-piston-cylinder area of a marine engine, especially of the piston-cylinder assembly.

Advantageously, as illustrated in the examples, the employment of a spiro compound according to the invention additionally makes it possible to significantly increase the stability to oxidation of the marine lubricant.

Thus, the employment of a spiro compound according to the invention makes it possible to achieve a marine lubricant exhibiting, under the temperature conditions encountered in the marine engine, excellent properties of thermal resistance, of engine cleanliness and of stability to oxidation, with a reduced ash content.

Moreover, advantageously, as illustrated in the examples which follow, the spiro compounds according to the invention, as a result in particular of the tetracovalent configuration of the boron or aluminum atom, are not hydrolyzable.

In other words, the spiro compounds according to the invention, in particular the spiroboronate compounds according to the invention, exhibit excellent stability when they are brought into contact with water (which would, for example, result from the combustion of the fuel or from condensation). The absence of decomposition/degradation of the spiro compounds in the presence of water makes it possible in particular to prevent, during the employment of the lubricating composition according to the invention, the formation of boric acid, a product classified as CMR (carcinogenic, mutagenic and reprotoxic).

The invention also relates to a process or a method for increasing the detergency capacity of a lubricating composition intended for a marine engine, in particular of a lubricating composition employing a reduced content of metallic detergents, in particular of calcium carbonate, indeed even devoid of metallic detergent, comprising the addition, to said lubricating composition, of at least one spiro compound according to the invention.

The process or method according to the invention advantageously makes it possible to increase the detergency capacity of said composition, while maintaining a low ash content.

The invention also relates, according to another of its aspects, to a process or a method of detergency of a marine engine, in particular of a four-stroke or two-stroke engine, comprising a stage of bringing at least one mechanical part of said marine engine, in particular at least a portion of the rings, piston and/or cylinder of said marine engine, into contact with a lubricating composition according to the invention as defined above.

It also relates to the use of at least one spiro compound according to the invention in a lubricant intended for the lubrication of a marine engine, in particular of the piston-cylinder assembly of a marine engine, for improving the engine cleanliness.

The invention also relates, according to another of its aspects, to a process or a method of lubrication of a marine engine, in particular of a four-stroke or two-stroke engine, comprising a stage of bringing at least one mechanical part of said marine engine, in particular at least a portion of the rings, piston and/or lining of said marine engine, into contact with a lubricating composition as defined above.

Other characteristics, alternative forms and advantages of the employment of a spiro compound according to the invention for the formulation of a marine lubricant will emerge more clearly on reading the description and the examples which follow, given by way of illustration and without limitation of the invention.

In the continuation of the text, the expressions “of between . . . and . . . ”, “ranging from . . . to . . .” and “varying from . . . to . . . ” are equivalent and are intended to mean that the limits are included, unless otherwise mentioned.

### BRIEF DESCRIPTION OF THE DRAWINGS

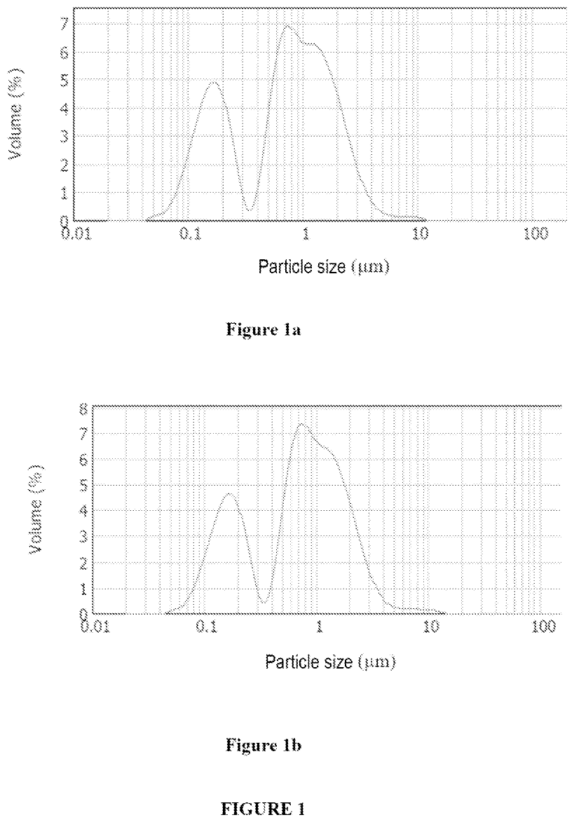

The distribution of the sizes of the particles for the spiroboronate-in-water emulsion obtained after paddle stirring (FIG. 1a) and after Ultra-Turrax® stirring (figure ib), as described in example 4, are presented in FIG. 1.

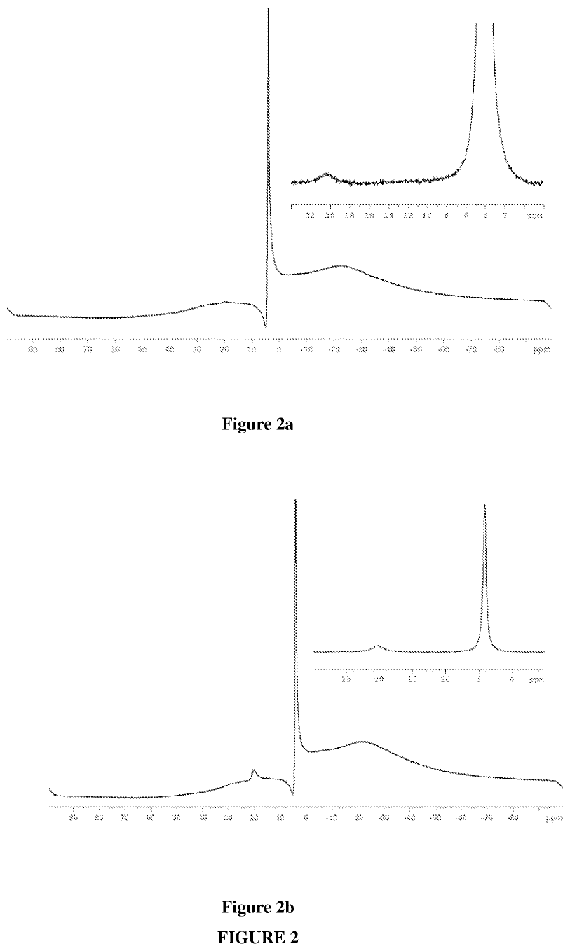

The NMR spectra of the pure spiroboronate (FIG. 2a) and of the residue (FIG. 2b) obtained as described in example 4 are presented in FIG. 2.

### DETAILED DESCRIPTION

### Spiro Compound

As indicated above, the invention is based on the employment, in a marine engine lubricant, of one or more specific spiro compounds, as detergent additive(s).

It is understood that the invention can employ a single spiro compound or a mixture of at least two distinct spiro compounds, in particular three or four distinct spiro compounds, especially as are defined below.

As mentioned above, the spiro compound considered according to the invention is of following formula (I):

### [Chem 2]

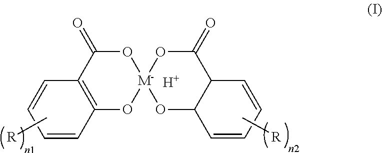 [0061] in which:
M is an atom chosen from boron and aluminum, in particular is a boron atom;
n1 and n2 have the value, independently of each other, of 0, 1 or 2; and
R represent, independently of one another, a hydrocarbon group comprising from 1 to 50 carbon atoms, in particular from 5 to 20 carbon atoms.

The hydrocarbon groups considered according to the invention can optionally be interrupted by one or more heteroatoms, for example —O—, —NH—, —N═ or —S—, in particular —O— or —NH—, and/or optionally be substituted by one or more —OH, —NH₂ and —SH, in particular —OH or —NH₂, groups.

According to a particular embodiment, the R¹ and R² groups are composed solely of carbon and hydrogen atoms.

The hydrocarbon groups can in particular be alkyl, alkenyl, aryl or aralkyl groups.

According to a particular embodiment, the R substituents represent, independently of one another, a hydrocarbon group, preferably a linear or branched aliphatic chain, comprising from 3 to 50 carbon atoms, especially from 3 to 30 carbon atoms, in particular from 5 to 25 carbon atoms and more particularly from 8 to 20 carbon atoms.

In particular, the R substituents can represent, independently of one another, a linear or branched aliphatic chain, especially a preferably linear C₁ to C₅₀, especially C₃ to C₃₀, in particular C₅ to C₂₅ and more particularly C₈ to C₂₀, for example C₁₀ or C₁₆, alkyl chain.

According to a particular embodiment, n1 and n2 have the value 0.

According to another particular embodiment, n1 and n2 have the value 1 or 2.

When n1 has the value 2 or n2 has the value 2, the R groups, carried by one and the same ring, can be identical or different.

In particular, the Spiro compound can be of abovementioned formula (I), in which n1 and n2 have the value 1, it being possible for the R substituents to be identical or different, preferably identical.

According to a particular embodiment, the Spiro compound is of abovementioned formula (I), in which:
n1 and n2 have the value 1; and
the R groups, which are identical, represent preferably linear C₁ to C₅₀, especially C₃ to C₃₀, in particular C₅ to C₂₅ and more particularly C₅ to C₂₀, more preferentially still C₁₆, alkyl groups.

According to a preferred embodiment, the spiro compound is of formula (I) in which M is a boron atom.

In other words, according to this particular embodiment, the spiro compound can be a “spiroboronate” compound, of following formula (I′):

### [Chem 3]

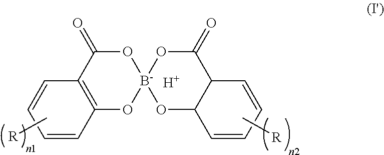 [0080] in which R, n1 and n2 are as defined above.

According to another particular embodiment, the spiro compound is of formula (I) in which M is an aluminum atom.

In other words, according to this particular embodiment, the spiro compound can be a “spiroaluminate” compound, of following formula (I″):

### [Chem 4]

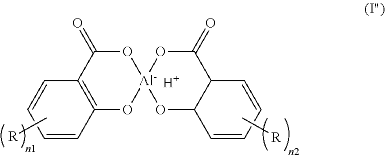 [0084] in which n1, n2 and R are as defined above.

The invention thus relates, according to another of its aspects, to a spiro compound of abovementioned formula (I), in which:
M is an aluminum atom;
n1 and n2, independently of each other, have the value 0, 1 or 2, at least one of n1 and n2 having the value 1 or 2; preferably, n1 and n2 have the value 1;
the R groups represent, independently of one another, a linear or branched aliphatic chain, in particular a preferably linear alkyl chain, comprising from 5 to 50 carbon atoms, especially from 6 to 30 carbon atoms, in particular from 8 to 25 carbon atoms and more particularly from 10 to 20 carbon atoms.

In other words, the invention relates to a compound of spiroaluminate type of abovementioned formula (I″), in which:
n1 and n2, independently of each other, have the value 0, 1 or 2, at least one of n1 and n2 having the value 1 or 2; preferably, n1 and n2 have the value 1; and
the R groups represent, independently of one another, a linear or branched aliphatic chain, in particular a preferably linear alkyl chain, comprising from 5 to 50 carbon atoms, especially from 6 to 30 carbon atoms, in particular from 8 to 25 carbon atoms and more particularly from 10 to 20 carbon atoms.

According to a particular embodiment, the compound of spiroaluminate type according to the invention is of formula (I″), in which:
n1 and n2 have the value 1; and
the R groups, which are identical or different, preferably identical, represent preferably linear alkyl chains comprising from 5 to 50 carbon atoms, especially from 6 to 30 carbon atoms, in particular from 8 to 25 carbon atoms and more particularly from 10 to 20 carbon atoms.

The spiro compound employed according to the invention can be prepared from salicylic acid or a salicylic acid derivative and from a boron compound or an aluminum compound. More particularly, it can be obtained by reaction:
of at least one compound chosen from salicylic acid and its derivatives, of following formula (Ia):

### [Chem 5]

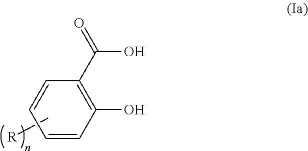 [0098] in which R is as defined above and n is as defined above for n1 and n2; and
of at least one boron or aluminum compound, in particular boric acid or aluminum hydroxide.

The preparation of the spiro compound employed in the lubricating composition according to the invention does not involve any stage, subsequent to the reaction of salicylic acid or of one of its derivatives with said boron or aluminum compound, of reaction with an amine compound, as is the case, for example, in the context of the preparation of the compounds provided in the applications WO2018/220007 and WO2018/220009.

Salicylic acid and its derivatives of abovementioned formula (Ia) can be synthesized according to methods of synthesis known to a person skilled in the art or may be commercially available.

The boron compound (in other words, boron-based compound) can be chosen in particular from boric acid (B(OH)₃), boronic acids, boric and boronic esters, boron oxide and boric acid complexes.

In particular, the boron compound can be chosen from boric acid; boron oxide; boric acid complexes; trialkyl borates, in particular in which the alkyl groups comprise, independently of one another, from 1 to 4 carbon atoms; boronic acids exhibiting a C₁-C₁₂ alkyl group; boric acids substituted by two alkyl groups, in particular C₁ to C₁₂ alkyl groups; boric acids substituted by two aryl groups, in particular C₆ to C₁₂ aryl groups; boric acids substituted by one or two aralkyl groups, in particular C₇ to C₁₂ aralkyl groups, and derivatives of these compounds obtained by substitution of at least one alkyl group by one or more alkoxy groups.

The boric acid complexes are in particular complexes of boron with one or more molecules comprising one or more alcohol functions.

According to a particular embodiment, the boron compound is boric acid.

The aluminum compound (in other words, aluminum-based compound) can be chosen in particular from aluminum hydroxide (Al(OH)₃), aluminum oxide or aluminum sulfate (Al₂(SO₄)₃).

It is up to a person skilled in the art to adjust the conditions of reaction between said compound(s) (Ia) and the boron or aluminum compound in order to obtain the desired spiro compound.

In particular, the reaction can be carried out in a solvent medium consisting of one or more nonpolar solvents and/or polar protic solvents.

The solvent medium can consist of one or more solvents chosen from naphtha, polar protic solvents, such as water and alcohols, for example methanol, ethanol, propanol or butanol, and their mixtures.

Advantageously, the reaction between salicylic acid or one of its derivatives of abovementioned formula (Ia) and the boron or aluminum compound in order to obtain the desired spiro compound, in particular the reaction between salicylic acid or one of its derivatives of formula (Ia) and the boron compound in order to obtain the desired spiroboronate compound, can be carried out in a nonpolar aprotic solvent medium, in particular in toluene.

In the context of the invention:
the term “hydrocarbon group” is understood to mean an aromatic or nonaromatic, linear, branched or cyclic, saturated or unsaturated, radical comprising carbon and hydrogen;
the term “aliphatic chain” is understood to mean a nonaromatic, saturated or unsaturated, linear or branched, hydrocarbon group consisting exclusively of carbon and hydrogen atoms.

Preferably, an aliphatic chain is an alkyl chain;
the term “alkyl” is understood to mean a saturated, linear or branched, aliphatic group; for example, a Cₓ to C_{z} alkyl represents a saturated, linear or branched, carbon chain of x to z carbon atoms;
the term “alkenyl” is understood to mean a linear or branched mono- or polyunsaturated aliphatic group;
the term “cycloalkyl” is understood to mean a cyclic alkyl group; for example, a Cₓ to C_{z} cycloalkyl represents a cyclic carbon group of x to z carbon atoms, for example a cyclopropyl, cyclobutyl, cyclopentyl, cyclohexyl or cycloheptyl;
the term “aryl” is understood to mean a mono- or polycyclic aromatic group, in particular comprising between 6 and 10 carbon atoms. Mention may be made, as examples of aryl groups, of the phenyl or naphthyl groups;
the term “aralkyl” is understood to mean an aryl group as defined above substituted by at least one alkyl group as defined above.

Said spiro compound(s) are advantageously employed in a content sufficient to achieve the required level of detergency capacity of the marine lubricant. Advantageously, even a small amount of spiro compound(s), in particular less than 3% by weight, with respect to the total weight of said lubricating composition, makes it possible to achieve the required detergency capacity, even in the absence of metallic detergents such as calcium-based detergents.

Of course, the amount of spiro compound(s) employed can be adjusted as a function of the composition of the marine lubricant, and more particularly taking into account the presence or absence and the amount employed of other detergent additive(s), in particular metallic additive(s), for example of calcium-based overbased and/or neutral detergents, present in the lubricant.

Generally, said spiro compound(s) considered according to the invention, in particular as defined above, can be employed in a proportion of 0.1% to 20% by weight, especially of 0.2% to 15% by weight, in particular of 0.5% to 10% and more particularly of 0.5% to 5% by weight, with respect to the total weight of said marine lubricating composition.

### Lubricating Composition

A lubricating composition for marine engines as considered according to the invention more particularly comprises one or more base oils and, optionally, other additives conventionally considered in marine lubricants.

It is understood that the nature and the amount of the other additives are adapted in the light of the purpose of the lubricant, and more particularly in the light of the type of marine engine for which it is intended.

### Base Oil

Conventionally, a marine lubricant according to the invention comprises one or more base oils.

These base oils can be chosen from the base oils conventionally used in the field of marine lubricants, such as mineral, synthetic or natural, animal or plant oils or their mixtures.

A mixture of several base oils, for example a mixture of two, three or four base oils, can be concerned.

The base oils of the marine lubricants considered according to the invention can in particular be oils of mineral or synthetic origins belonging to Groups I to V according to the classes defined in the API classification (or their equivalents under the ATIEL classification) and presented in table A below or their mixtures.

TABLE 1
Table A

| | Content of saturated | Sulfur | Viscosity index |
|---|---|---|---|
| | compounds | content | (VI) |
| Group I | <90% | >0.03% | 80 ≤ VI < 120 |
| Mineral oils | | | |
| Group II | ≥90% | ≤0.03% | 80 ≤ VI < 120 |
| Hydrocracked oils | | | |
| Group III | ≥90% | ≤0.03% | ≥120 |
| Hydrocracked or | | | |
| hydroisomerized oils | | | |

| | |
|---|---|
| Group IV | Poly-α-olefins (PAOs) |
| Group V | Esters and other bases not |
| | included in Groups I to IV |

The mineral base oils include all types of base oils obtained by atmospheric and vacuum distillation of crude oil, followed by refining operations such as solvent extraction, deasphalting, solvent dewaxing, hydrotreating, hydrocracking, hydroisomerization and hydrofinishing. The mineral bases of Group I are, for example, bases called Neutral Solvent (such as, for example, 150NS, 330NS, 500NS or 600NS) or Brightstock.

The synthetic base oils can be esters of carboxylic acids and of alcohols, poly-α-olefins or also polyalkylene glycols (PAGs) obtained by polymerization or copolymerization of alkylene oxides comprising from 2 to 8 carbon atoms, in particular from 2 to 4 carbon atoms. The poly-α-olefins used as base oils are, for example, obtained from monomers comprising from 4 to 32 carbon atoms, for example from decene, octene or dodecene, and the viscosity of which at 100° C. is of between 1.5 and 15 mm²·s⁻¹ according to the standard ASTM D445. Their average molecular weight is generally of between 250 and 3000 according to the standard ASTM D5296.

Mixtures of synthetic and mineral oils, which can be biobased, can also be employed. There generally exists no limitation with regard to the employment of different base oils in the lubricating composition, apart from the fact that they must have properties, in particular of viscosity, of viscosity index, of sulfur content or of resistance to oxidation, which are suitable for use for the lubrication of marine engines.

In particular, the lubricating compositions according to the invention have an SAE-20, SAE-30, SAE-40, SAE-50 or SAE-60 viscometric grade according to the SAEJ300 classification, equivalent to a kinematic viscosity at 100° C. of between 5.6 and 26.1 mm²/s, measured according to the standard ASTM D445.

Grade 40 oils have a kinematic viscosity, measured according to the standard ASTM D445, at 100° C., of between 12.5 and 16.3 mm²/s. Grade 50 oils have a kinematic viscosity, measured according to the standard ASTM D445, at 100° C., of between 16.3 and 21.9 mm²/s. Grade 60 oils have a kinematic viscosity, measured according to the standard ASTM D445, at 100° C., of between 21.9 and 26.1 mm²/s.

The base oil(s) can be present in a lubricating composition according to the invention in a content of at least 50% by weight, with respect to its total weight, in particular of at least 60% by weight, more particularly ranging from 65% to 99% by weight and preferably from 70% to 98% by weight, for example ranging from 65% to 95% by weight.

### Additives

A lubricating composition according to the invention can comprise all types of additives commonly employed in marine lubricants.

It is understood that the nature of the other additives employed is chosen so as not to negatively impact the properties sought for the marine lubricant.

These additives can be introduced in isolation and/or in the form of a mixture, or “additive package”, such as those already available for sale for commercial lubricating formulations for marine engines.

These additives, distinct from said spiro compound(s), can in particular be chosen from other detergent additives, distinct from said spiro compound(s), especially overbased and neutral metallic detergent additives, basic organic additives which improve the total base number (TBN), antiwear additives, dispersing additives, a viscosity index (VI) improver, thickeners, antifoaming agents, antioxidizing additives, rust-inhibiting additives and their mixtures.

### Other Detergents

A marine lubricant considered according to the invention, incorporating one or more spiro compounds according to the invention, in particular as defined above, can comprise one or more other detergent additives, in particular one or more metallic detergent additives.

As mentioned above, metallic detergents are known to a person skilled in the art to provide high levels of detergency. However, these metallic compounds exhibit the disadvantage of being generators of sulfated ash.

They are generally anionic compounds comprising a long lipophilic hydrocarbon chain and a hydrophilic head, it being possible for the associated cation to be a metallic cation of an alkali or alkaline earth metal.

They are generally chosen from alkali metal or alkaline earth metal salts of carboxylic acids, in particular sulfonates, salicylates, naphthenates, phenates, carboxylates and the mixtures of these. The alkali and alkaline earth metals are preferentially calcium, magnesium, sodium or barium.

These metal salts generally comprise the metal in a stoichiometric amount (reference is then made to nonoverbased or “neutral” detergents) or else in excess, thus in a greater amount than the stoichiometric amount. In the latter case, they are overbased detergent additives; the excess metal contributing the overbased nature to the detergent additive is then generally in the form of a metal salt which is insoluble in the base oil, for example a carbonate, a hydroxide, an oxalate, an acetate or a glutamate, preferentially a carbonate.

According to a particular embodiment, a marine lubricant according to the invention comprises at least one metallic detergent additive, distinct from said spiro compound(s), in particular at least one overbased detergent additive and/or at least one neutral detergent additive.

In particular, the overbased detergent and/or the neutral detergent are compounds based on metals chosen from calcium, magnesium, sodium and barium, preferentially based on calcium or magnesium.

Preferably, the overbased detergent is overbased by insoluble metal salts chosen from the group of alkali metal and alkaline earth metal carbonates, preferentially calcium carbonate. The overbased detergent employed in a marine lubricant according to the invention can be chosen in particular from phenates, sulfonates, salicylates, carboxylates and mixed detergents (phenates-sulfonates-salicylates) overbased with calcium carbonate, more particularly from sulfonates and phenates overbased with calcium carbonate.

The content of metallic detergents, in particular of overbased detergents and/or of neutral detergents as described above, included in a marine lubricant according to the invention can be adjusted in particular so as to achieve the desired value of the total base number of the lubricant.

In particular, a marine lubricant according to the invention can exhibit a total base number, TBN, measured according to the standard ASTM D2896, of less than or equal to 140 mg KOH per gram of lubricant, especially of between 5 and 140 mg KOH/g of lubricant, especially between 5 and 100 mg KOH/g of lubricant, in particular of between 10 and 60 mg KOH/g of lubricant.

According to a particular embodiment, a lubricant for a marine engine according to the invention comprises at least:
one or more base oils;
at least one spiro compound according to the invention, in particular at least one spiroboronate compound according to the invention; and
at least one metallic detergent additive distinct from said spiro compound, especially at least one overbased detergent and/or one neutral detergent as defined above, in particular based on calcium or on magnesium.

Advantageously, as indicated above, by the addition of one or more spiro compounds according to the invention, making it possible to contribute the detergency capacity required for the marine lubricant, the content of metallic detergent additives as defined above, which are undesirable in the light of the ash which they generate, can be reduced, while retaining good detergency properties.

According to a particular embodiment, the marine lubricating composition according to the invention can comprise less than 25% by weight, especially from 0.1% to 25% by weight, more particularly from 5% to 15% by weight, of metallic detergent additive(s) distinct from the spiro compounds according to the invention, with respect to the total weight of said composition.

According to a particular embodiment, the lubricating composition according to the invention can comprise less than 15% by weight, especially less than 10% by weight and more particularly from 0.1% to 10% by weight, especially from 0.5% to 5% by weight, of metallic detergent additive(s) distinct from the spiro compounds according to the invention, with respect to the total weight of said composition.

In particular, said metallic detergent additive(s) can be present in the lubricating composition so as to provide a content of metal element(s), in particular of calcium, of less than or equal to 10 000 ppm, especially ranging from 100 ppm to 10 000 ppm, preferably from 250 ppm to 6000 ppm.

According to a particular embodiment, a marine lubricant according to the invention can comprise:
from 60% to 98.9% by weight, in particular from 65% to 98% by weight, of one or more base oils;
from 0.1% to 20% by weight, especially from 0.2% to 15% by weight and more particularly from 0.5% to 10% by weight of at least one spiro compound according to the invention as defined above and more particularly of at least one spiroboronate compound according to the invention,
optionally from 1% to 30% by weight, especially from 5% to 25% by weight, of one or more metallic detergent additives, distinct from said spiro compound according to the invention, especially chosen from the overbased and neutral metallic detergents as defined above, in particular based on calcium or on magnesium;
the contents being expressed with respect to the total weight of said marine lubricant.

Furthermore, according to a particular embodiment, a lubricating composition according to the invention does not comprise a fatty amine, especially of triamine or tetraamine type.

### Other Additives

A lubricating composition considered according to the invention can also comprise at least one basic organic additive making it possible to increase the total base number, referred to as TBN, of the lubricating composition.

These basic organic additives, referred to as “TBN booster”, make it possible to increase the total base number of the composition; in other words, they are capable of neutralizing the acids and make it possible to achieve improved detergency performance qualities.

Basic organic additives which improve the TBN are known to a person skilled in the art. They can in particular be amino, alkylated or aromatic organic additives or also nitrogenous dispersants.

In particular, said basic organic additive(s) which improve the TBN can be employed in a content of greater than or equal to 0.1% by weight, with respect to the total weight of said lubricating composition, especially in a content of between 0.1% and 10% by weight, more particularly between 0.5% and 7% by weight, preferably between 1% and 5% by weight.

A lubricating composition considered according to the invention can also comprise at least one antifoaming additive, especially employed to counter the effect of the metallic detergents. The antifoaming additives can be chosen from polar polymers, such as polymethylsiloxanes or polyacrylates; succinimides and their derivatives, especially from polyisobutylene succinimide (PIBSI) or polyisobutylene succinic anhydride (PIBSA). In particular, a lubricating composition considered according to the invention can comprise from 0.01% to 3% by weight of antifoaming additive(s), with respect to the total weight of the lubricating composition.

A lubricating composition considered according to the invention can also comprise a viscosity index (VI) improver. Viscosity index (VI) improvers, especially polymers which improve the viscosity index, make it possible to guarantee a good cold resistance and a minimum viscosity at high temperatures. Mention may be made, as examples of a polymer which improves the viscosity index, of polymeric esters, hydrogenated or nonhydrogenated homopolymers or copolymers of styrene, of butadiene and of isoprene, homopolymers or copolymers of an olefin, such as ethylene or propylene, polyacrylates and polymethacrylates (PMAs).

In particular, the additive(s) which improve the viscosity index can be present in a lubricating composition according to the invention in a content ranging from 1% to 15% by weight, especially from 2% to 10% by weight, with respect to the total weight of the lubricating composition.

A lubricating composition according to the invention can comprise at least one antiwear and/or extreme-pressure additive. The antiwear additives protect the surfaces from friction by formation of a protective film adsorbed on these surfaces.

A wide variety of antiwear additives exists. Preferably, for the lubricating composition according to the invention, the antiwear additives are chosen from phospho-sulfur additives, such as metal alkylthiophosphates, in particular zinc alkylthiophosphates and more specifically zinc dialkyldithiophosphates or ZnDTPs. The preferred compounds are of formula Zn(SP(S)(OR³)(OR⁴))₂, in which R³ and R⁴, which are identical or different, independently represent an alkyl group, preferentially an alkyl group comprising from 1 to 18 carbon atoms.

Amine phosphates, polysulfides, in particular sulfur-containing olefins, are also antiwear additives which can be employed in the lubricating composition according to the invention. Advantageously, the extreme-pressure and/or antiwear additive(s) can be present in a lubricating composition according to the invention in a content ranging from 0.01% to 6% by weight, preferentially from 0.05% to 4% by weight, more preferentially from 0.1% to 2% by weight, with respect to the total weight of the lubricating composition.

A lubricating composition considered according to the invention can comprise at least one antioxidizing additive. The antioxidizing additives are essentially dedicated to delaying the degradation of the lubricating composition in service. This degradation can in particular be reflected by the formation of deposits or by an increase in the viscosity of the lubricating composition. They act in particular as radical inhibitors or destroyers of hydroperoxides.

Mention may be made, among the commonly employed antioxidizing additives, of antioxidizing additives of phenolic type, antioxidizing additives of amino type or phospho-sulfur antioxidizing additives. Some of these antioxidizing additives, for example phospho-sulfur antioxidizing additives, can be generators of ash. Phenolic antioxidizing additives can be devoid of ash or else be in the form of neutral or basic metal salts. The antioxidizing additives can in particular be chosen from sterically hindered phenols, sterically hindered phenol esters and sterically hindered phenols comprising a thioether bridge, diphenylamines, diphenylamines substituted by at least one C₁-C₁₂ alkyl group, N,N′-dialkylaryldiamines and their mixtures.

Preferably, the sterically hindered phenols are chosen from compounds comprising a phenol group, at least one vicinal carbon of the carbon carrying the alcohol function of which is substituted by at least one C₁-C₁₀ alkyl group, preferably a C₁-C₆ alkyl group, preferably a C₄ alkyl group, preferably by the tert-butyl group.

Amino compounds are another class of antioxidizing additives which can be used, optionally in combination with the phenolic antioxidizing additives. Examples of amino compounds are aromatic amines, for example the aromatic amines of formula NR⁵R⁶R⁷ in which R⁵ represents an aliphatic group or an aromatic group, which is optionally substituted, R⁶ represents an aromatic group, which is optionally substituted, R⁷ represents a hydrogen atom, an alkyl group, an aryl group or a group of formula R⁸S(O)₂R⁹ in which R⁸ represents an alkylene group or an alkenylene group, R⁹ represents an alkyl group, an alkenyl group or an aryl group and z represents 0, 1 or 2.

Sulfurized alkylphenols or their alkali metal and alkaline earth metal salts can also be used as antioxidizing additives.

A lubricating composition considered according to the invention can contain any type of antioxidizing additive known to a person skilled in the art.

Advantageously, the antioxidizing additive(s) can be present in a lubricating composition according to the invention in a content ranging from 0.01% to 10% by weight, preferentially from 0.05% to 8% by weight, more preferentially from 0.1% to 5% by weight, more preferentially still from 0.1% to 2% by weight, with respect to the total weight of the lubricating composition.

As indicated above, the spiro compound according to the invention makes it possible to provide the marine lubricant with an excellent stability to oxidation.

Thus, the present invention also relates to the use of at least one spiro compound of formula (I) as defined according to the present invention, as additive in a lubricating composition intended for a marine engine, for improving the stability to oxidation of said lubricating composition.

Consequently, a marine lubricant according to the invention can advantageously comprise a content of antioxidizing additive(s) of less than or equal to 10% by weight, in particular of less than or equal to 5% by weight, in particular ranging from 0.1% to 2% by weight, with respect to the total weight of said lubricant, indeed even be completely devoid of other antioxidizing additive.

A lubricating composition considered according to the invention can also comprise at least one dispersing agent. The dispersing agents ensure the maintenance in suspension and the discharge of the insoluble solid contaminants consisting of the oxidation byproducts which are formed when the lubricating composition is in service or of the combustion residues, nonincinerated materials or any other contaminant. They can be chosen from Mannich bases, succinimides and their derivatives.

In particular, a lubricating composition considered according to the invention can comprise from 0.2% to 10% by weight of dispersing agent(s), with respect to the total weight of the composition.

As mentioned above, the combined additives described in detail above can be introduced in the form of a mixture or “package” of additives.

According to this embodiment, the additive package can represent from 1% to 35% by weight, especially from 2% to 30% by weight, with respect to the total weight of the composition, preferably ranging from 5% to 25% by weight.

According to a particular embodiment, a lubricating composition for a marine engine according to the invention can comprise, indeed even consist of:
a base oil or a mixture of base oils;
one or more spiro compounds according to the invention, in particular as defined above, and more particularly one or more spiroboronate compounds according to the invention;
optionally one or more additives, distinct from said spiro compound(s), chosen from: other detergent additives, in particular overbased and neutral metallic detergent additives; antiwear additives; basic organic additives which improve the total base number; dispersing additives; viscosity index (VI) improvers; thickeners; antifoaming agents; antioxidizing additives; rust-inhibiting additives; and their mixtures.

Preferably, a lubricating composition for a marine engine according to the invention comprises, indeed even consists of:
from 60% to 98.9% by weight, in particular from 70% to 90% by weight, of one or more base oils;
from 0.1% to 20% by weight, preferably from 0.5% to 10% by weight, of one or more spiro compounds according to the invention, in particular as defined above, and more particularly of one or more spiroboronate compounds according to the invention;
from 1% to 35% by weight, preferably from 5% to 25% by weight, of one or more additive(s) chosen from: other detergent additives, in particular chosen from overbased and neutral metallic detergent additives; basic organic additives which improve the total base number; antiwear additives; dispersing additives; viscosity index (VI) improvers; thickeners; antifoaming agents; antioxidizing additives; rust-inhibiting additives; and their mixtures; the contents being expressed with respect to the total weight of said lubricating composition.

In particular, a lubricating composition for a marine engine according to the invention can comprise, indeed even consist of:
from 60% to 97.9% by weight, in particular from 70% to 90% by weight, of one or more base oils;
from 0.1% to 20% by weight, preferably from 0.5% to 10% by weight, of spiro compound(s) according to the invention, in particular as defined above, and more particularly of one or more spiroboronate compounds according to the invention;
from 1% to 30% by weight, especially from 5% to 25% by weight, of one or more metallic detergent additives, distinct from said spiro compound(s), especially chosen from the overbased and neutral metallic detergents as defined above, in particular based on calcium or on magnesium; and
optionally from 1% to 30% by weight, in particular from 3% to 20% by weight, of one or more other additives chosen from: basic organic additives which improve the total base number; antiwear additives; dispersing additives; viscosity index (VI) improvers; thickeners; antifoaming agents; antioxidizing additives; rust-inhibiting additives; and their mixtures; the contents being expressed with respect to the total weight of said lubricating composition.

### Application

As indicated above, a lubricating composition according to the invention is suitable for the lubrication of four-stroke or two-stroke engines.

The invention thus relates, according to another of its aspects, to the use of a composition as defined above, incorporating one or more spiro compounds as detergent additive, for lubricating a marine engine.

Its good properties of thermal resistance and of stability to oxidation make it particularly suitable as a cylinder oil, in other words for the lubrication of at least the piston-ring-liner area of a marine engine, and/or as a system oil, for the lubrication of the moving parts of the engine outside the piston-ring-liner assembly.

It can be employed for slow, semi-fast or fast marine engines.

It can be employed in particular for diesel marine engines.

It can also be employed for marine engines, the fuel of which is obtained at least partially from organic matter, or biofuel, such as biodiesel, bioethanol or also ammonia.

All of the particular characteristics and embodiments relating to the spiro compound of formula (I) and to the lubricating composition comprising it also apply to the uses, processes and methods targeted according to the invention.

The invention will now be described by means of the following examples, given by way of illustration and without limitation of the invention.

### EXAMPLE

### Example 1

### Preparation of the Lubricating Compositions

Various lubricating compositions were prepared from the following compounds:
lubricating base oil 1: Group I mineral oil, with a viscosity at 40° C. of 120 mm²/s, measured according to the standard ASTM D7279;
lubricating base oil 2: Group I mineral oil, with a viscosity at 40° C. of 500 mm²/s, measured according to the standard ASTM D7279;
additive package comprising a metallic detergent additive of neutral phenate type (sulfurized calcium phenate with a BN equal to 116 mg KOH/g of phenate); a metallic detergent additive of the type of sulfonate overbased with calcium carbonate (BN equal to 400 mg KOH/g of overbased sulfonate) and a silicon-based antifoaming agent;
a spiroboronate compound according to the invention (spiro compound of formula (I) according to the invention in which M is a boron atom, R each represent a C₁₆ alkyl group and n1 and n2 have the value 1).

The components and their amounts (expressed as percentage by weight with respect to the total weight of the composition) for the various lubricants are shown in the following table. The lubricants are formulated by simple mixing at 60° C. of the various components.

TABLE 2

| | CC1 | I1 | I2 |
|---|---|---|---|
| Base oil 1 | 57.97 | 55.13 | 64.13 |
| Base oil 2 | 33.00 | 33.00 | 33.00 |
| Neutral phenate | 7.00 | 7.00 | — |
| Sulfonate overbased with | 2.00 | 2.00 | — |
| CaCO₃ | | | |
| Antifoaming agent | 0.03 | 0.03 | 0.03 |
| Spiroboronate of the invention | — | 2.84 | 2.84 |

The lubricants are characterized by their total base number, denoted TBN, expressed in mg KOH/g and evaluated according to the standard ASTM D-2896.

TABLE 3

| Lubricant | CC1 | I1 | I2 |
|---|---|---|---|
| TBN in mg of KOH/g | 17 | 17 | 0 |

### Evaluation of the Thermal Resistance Properties of the Lubricants

### Continuous ECBT Test

The thermal resistance of the lubricants prepared in example 1 was evaluated by the implementation of the continuous ECBT test. This test makes it possible to simulate both the thermal stability and the detergency of marine lubricants when the lubricating composition originating from the crankcase is sprayed over the hot portion of a marine engine and, in particular, at the top of the piston.

A detailed description of this test is given in the publication entitled “Research and Development of Marine Lubricants in ELF ANTAR France—The Relevance of Laboratory Tests in Simulating Field Performance” by Jean-Philippe Roman, Marine Propulsion Conference, 2000—Amsterdam—Mar. 29-30, 2000.

### Stop & Go ECBT Test

The same type of test, as described above for the continuous ECBT test, is carried out under cyclic conditions.

This test reflects the behavior of the lubricant in the area of the belt of the piston rings.

The products tested are sprayed into the beaker according to cyclical sequences during which the duration of the stopping step is three times greater than the duration of the starting step. The test temperatures are chosen between 270° C. and 310° C., and the duration of the test is one hour. At the end of a cycle, the cooling of the beaker is carried out naturally, without splashes, which contributes strongly to the formation of varnish. The final result of the Stop & Go test is based on a visual evaluation, according to a method described in the abovementioned publication by Jean-Philippe Roman.

The method is as follows: A video-grading based both on the color of the varnish and on the degree of coverage of the surface is carried out. The grading is carried out on a scale of 0 to 100 points. Curves reporting the performance qualities of each composition for at least three temperatures are plotted on a graph. When the curve crosses the level 50 of the performance index on a merit scale of 100, the corresponding temperature is noted.

### Results

The results obtained for each of the lubricants are collated in the following table.

### Results of the Continuous ECBT Test

TABLE 4

| Lubricant | CC1 | I1 | I2 |
|---|---|---|---|
| Continuous ECBT (mg) | 343 | 370 | 70 |

These results show that the replacement of the metallic detergents by a spiroboronate according to the invention results in an improvement in the thermal resistance of the lubricant under the high-temperature conditions encountered in the hot portion of the engine.

The lubricants incorporating a spiroboronate compound according to the invention, in complete or partial replacement of metallic detergent additives, thus form fewer carbon deposits under the conditions of employment in a marine engine, in other words exhibit improved detergency properties, and thus make it possible to improve the cleanliness of the engine.

### Results of the Stop & go ECBT Test

TABLE 5

| Lubricant | CC1 | I1 | I2 |
|---|---|---|---|
| Temperature (in ° C.)⁽*⁾ | 284 | 294 | 304 |

⁽*⁾corresponding to the level 50 of the performance index on a merit scale of 100

These results show that the employment, in a marine lubricant, of a spiroboronate compound according to the invention, in addition to metallic detergent additives, indeed even in replacement of metallic detergent additives, makes it possible to improve the thermal stability of the lubricant under conditions which reflect those employed in the belt of the piston rings of a marine engine, and thus the detergency properties.

### Example 3

### Evaluation of the Properties of Stability to Oxidation of the Lubricants

The stability to oxidation is evaluated by pressure differential scavenging calorimetry, which determines the oxidation induction time (OIT) for lubricating compositions. This is a standard procedure in the lubricating oil industry based on the standard CEC L-85 T-99. According to this protocol, the lubricating composition to be tested is heated to a high temperature, generally of approximately 25° C. below the mean decomposition temperature for the sample tested (in this case, from 50° C. to 210° C.), and the time at which the lubricant begins to decompose is measured. The longer the duration of the test, expressed in minutes, the better the stability to oxidation of the lubricant.

### Results

The results obtained for each of the lubricants are collated in the following table.

TABLE 6

| Lubricant | CC1 | I1 |
|---|---|---|
| Oxidation induction time (in min) | 97 | >250 |

These results show that the addition of a spiroboronate compound according to the invention makes it possible to significantly improve the stability to oxidation of the lubricant.

### Example 4

### Evaluation of the Stability of the Spiroboronate Compound in the Presence of Water

The stability to water of a spiroboronate compound in accordance with the invention was evaluated as described below.

The spiroboronate compound tested is a spiro compound of formula (I) in which M is a boron atom, R each represent an octadecyl (Cis) chain, and n1 and n2 have the value 1, in other words is of following formula:

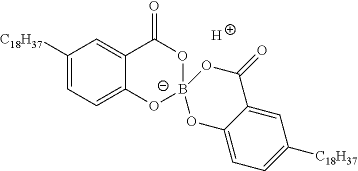

The spiroboronate compound was prepared from the salicylic acid derivative (2-hydroxy-5-octadecylbenzoic acid), synthesized beforehand, and boric acid. 2-Hydroxy-5-octadecylbenzoic acid (8.9 g, 22.8 mmol, 2 equiv) and boric acid (0.70 g, 11.4 mmol, 1.0 equiv) in toluene (65 ml) were introduced into a 250 ml three-necked round-bottomed flask equipped with a Dean and Stark apparatus, to remove the water, and with a mechanical stirrer under nitrogen. The mixture was heated at reflux until the end of the reaction, and the spiroboronate compound was recovered.

The spiroboronate compound was dispersed at 5% by weight in water. The emulsion was subjected to vigorous paddle stirring, followed by stronger stirring using an Ultra-Turrax® stirrer.

The emulsions obtained after each stirring were stable. They were analyzed by laser particle size analysis using a Malvern Mastersizer 2000 particle size analyzer.

The distribution of the sizes of the particles for the emulsion obtained after paddle stirring (FIG. 1a) and after Ultra-Turrax® stirring (FIG. 1b) is presented in FIG. 1.

The emulsion of the spiroboronate in water was subsequently passed to a vacuum rotary evaporator, in order to evaporate the water. The residue resulting from the evaporation of the water was recovered and analyzed by ¹H NMR.

The NMR spectrum of the residue was compared with that of the pure spiroboronate compound.

The NMR spectra of the pure spiroboronate (FIG. 2a) and of the residue obtained as described above (FIG. 2b) are presented in FIG. 2.

The comparison of the two spectra shows that the residue obtained corresponds to the starting spiroboronate. Thus, the spiroboronate compound has not undergone hydrolysis in the presence of water.

1. Use, as detergent additive in a lubricating composition intended for a marine engine, of at least one spiro compound of following formula (I) 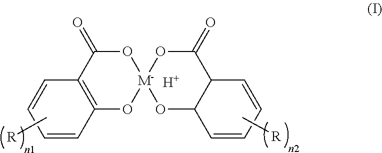
in which
M is an atom chosen from boron and aluminum;
n1 and n2 have the value, independently of each other, of 0, 1 or 2; and
R represent, independently of one another, a hydrocarbon group comprising from 1 to 50 carbon atoms, in particular from 5 to 20 carbon atoms.

2. The use as claimed in the preceding claim, said spiro compound being of formula (I) in which the R substituents represent, independently of one another, a linear or branched aliphatic chain, especially a preferably linear C₁ to C₅₀, especially C₃ to C₃₀, in particular C₅ to C₂₅ and more particularly C₅ to C₂₀, more preferentially C₁₆, alkyl chain.

3. The use as claimed in claim 1 or 2, said spiro compound being of formula (I) in which n1 and n2 have the value 1, the R groups being identical.

4. The use as claimed in any one of the preceding claims, said spiro compound being of formula (I) in which M is a boron atom.

5. The use as claimed in any one of the preceding claims, said spiro compound(s) being employed in a content of between 0.1% and 20% by weight, with respect to the total weight of said lubricating composition, preferably of between 0.2% and 15% by weight, more preferably between 0.5% and 10% by weight and more particularly from 0.5% to 5% by weight.

6. The use as claimed in any one of the preceding claims, said lubricating composition comprising at least one metallic detergent additive, distinct from the spiro compound of formula (I), in particular at least one overbased metallic detergent additive and/or one neutral metallic detergent additive, in particular based on calcium.

7. The use as claimed in any one of the preceding claims, said composition comprising one or more base oils in a content of at least 50% by weight, with respect to its total weight, in particular of at least 60% by weight, more particularly ranging from 65% to 99% by weight and preferably from 70% to 98% by weight.

8. The use as claimed in any one of the preceding claims, said composition comprising one or more other additives, distinct from said spiro compound(s), chosen from: basic organic additives which improve the total base number; antiwear additives; dispersing additives; a viscosity index (VI) improver; thickeners; antifoaming agents; antioxidizing additives; rust-inhibiting additives; and their mixtures.

9. The use as claimed in any one of the preceding claims, said composition being of SAE-20, SAE-30, SAE-40, SAE-50 or SAE-60 viscometric grade according to the SAEJ300 classification.

10. The use as claimed in any one of the preceding claims, said lubricating composition being a lubricant for a two-stroke or four-stroke engine, in particular a lubricant intended for the lubrication of the piston-ring-liner assembly of said marine engine.

11. The use of at least one spiro compound of formula (I) as defined in any one of claims 1 and 5 as additive in a lubricating composition intended for a marine engine, for improving the stability to oxidation of said lubricating composition.

12. A lubricating composition intended for the lubrication of a marine engine, comprising at least:
one or more base oils;
at least one spiro compound of formula (I) as defined in any one of claims 1 to 5;
optionally one or more additives, distinct from said spiro compound(s), chosen from: other detergent additives, in particular overbased and neutral metallic detergent additives; antiwear additives; dispersing additives; viscosity index (VI) improvers; thickeners; antifoaming agents; antioxidizing additives; rust-inhibiting additives; and their mixtures.

13. The lubricating composition as claimed in the preceding claim, said composition being as defined in claims 9 and 10.

14. A process of lubrication of a marine engine, in particular of a two-stroke or four-stroke marine engine, comprising a stage of bringing at least one mechanical part of said marine engine, in particular at least a portion of the rings, piston and/or lining of said marine engine, into contact with a lubricating composition as defined according to claim 12 or 13.
